(19) United States
(12) Patent Application Publication
(10) Pub. No.: US 2026/0321489 A1
(43) Pub. Date: Oct. 15, 2026

(54) Precision Directional Coupler

(71) Applicant: Comcast Cable Communications, LLC, Philadelphia, PA (US)

(72) Inventors: Clyde Robbins, Bensalem, PA (US); Nicholas Stefano, Haddon Heights, NJ (US)

(21) Appl. No.: 19/643,946

(22) Filed: Apr. 10, 2026

Related U.S. Application Data
(60) Provisional application No. 63/786,647, filed on Apr. 10, 2025.

(51) Int. Cl. H01F 38/14; H01F 27/02; H01F 27/26; H01F 27/28; H01F 41/02

(52) U.S. Cl. CPC H01F 38/14; H01F 27/022; H01F 27/266; H01F 27/2823; H01F 41/0246; H01F 2038/143

(57) ABSTRACT

A coupling device may comprise a magnetic core and wire windings. The magnetic core may comprise a plurality of channels configured to position the wire windings. The channels may prevent shift of position for the wire windings and may provide isolation stability for the coupling device.

### CROSS-REFERENCE TO RELATED APPLICATIONS

This application claims the benefit of U.S. Provisional Application No. 63/786,647 filed on Apr. 10, 2025. The above-referenced application is hereby incorporated by reference in its entirety.

### FIELD OF INVENTION

The invention relates to telecommunication, and more particularly magnetic inductive devices such as coupling devices.

### BACKGROUND

Coupling devices such as bi-directional coupling devices are used in telecommunications systems such as DOCSIS 4.0 full duplex (FDX) systems, where high isolation (e.g., 40dB) is required. A bidirectional coupler is formed by winding wires on a magnetic core and tuned to achieve desired echo cancellation.

### SUMMARY

The following summary presents a simplified summary of certain features. The summary is not an extensive overview and is not intended to identify key or critical elements.

A coupling device may comprise a magnetic core having a plurality of channels configured to position wire windings. The channels may prevent shift of position for the wire windings, for example, during a reflow soldering process or during temperature changes. The channels may comprise various shapes such as a V-shape, a U-shape, or a curved shape, and may be shaped to conform to an outer contour of a wire. The channels may have a depth that is larger than or equal to a diameter of a wire winding, or a depth that is smaller than a diameter of a wire winding. The channels may comprise uneven inner surfaces configured to increase friction with a wire winding positioned in the channel. The channels may be formed in an inner surface of a hole of the magnetic core, in an outer surface of a hole of the magnetic core, and/or in an end surface of the magnetic core. The channels may be parallel to each other, and intervals between channels may correspond to predetermined intervals between windings. A quantity of channels may correspond to a quantity of wire windings, or the quantity of channels may be larger than the quantity of wire windings to provide flexibility for positioning wire windings. The channels may be formed as part of a molding process for the magnetic core, for example, by using a mold designed to include predetermined configurations for forming the channels. Alternatively, the channels may be formed after the magnetic core is molded. The coupling device may be a bidirectional coupler comprising a substrate attached to the magnetic core, a tuning wire protruding from the magnetic core, and an encapsulant applied on the substrate. By using wire channels in a magnetic core, advantages such as isolation stability of the coupling device may be achieved.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example coupling device.

FIG. 2A shows a simplified example of a coupling device with wire channels.

FIG. 2B shows an example of wire channels on a coupling device.

FIG. 2C shows an example of wire channels on a coupling device.

FIG. 3 shows an example of wire windings in wire channels.

FIGS. 4A, 4B and 4C show examples of distributions and sizes of wire channels.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

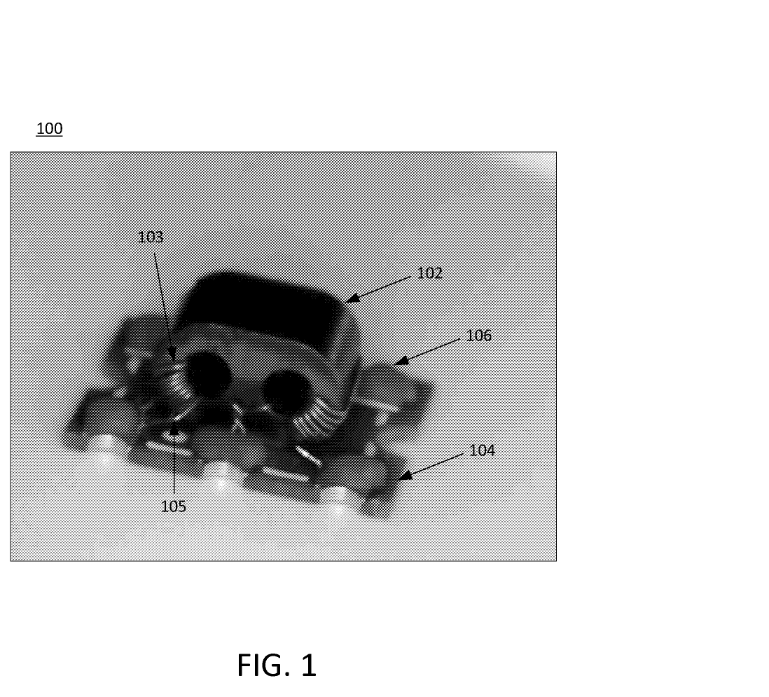

FIG. 1 shows an example coupling device. The example coupling device 100 may be a bidirectional coupler, for example, used in a DOCSIS 4.0 full duplex (FDX) system. In the DOCSIS 4.0 FDX system, a FDX operation may allow for bi-directional signals to flow simultaneously in the same frequency band. A bidirectional coupler may be used to isolate the upstream and downstream traffic. A FDX system may require a high isolation and high stability coupler. A target isolation may be 40 dB from the bidirectional coupler in the FDX system, which may be significantly higher than the isolation (e.g., 20 dB) required in other applications for bidirectional couplers. A bidirectional coupler may be formed by winding wires on a magnetic core and may be tuned to achieve desired echo cancellation (e.g., null of response, e.g., in a 500-600 MHz range). A tuned coupler may be attached to a printed circuit board using a reflow (or re-flow) soldering process, for example, to produce a FDX modem. The reflow soldering process may generate heat which may cause a shift in the physical positions of the wires on the magnetic core of the bidirectional coupler. For example, the wires and/or the magnetic core may expand under heat. The position shift may cause loss of isolation in the bidirectional coupler, which may result in around 3% failure rate in the production of FDX modems. In some other situations such as in outside amplifier applications, wide temperature swings may occur. Such temperature swing may cause wires to expand and contract. The wires may shift their locations and the isolation of a tuned coupler may change. Various attempts have been made to solve this problem. For example, adhesives (e.g., epoxy or other adhesives) may be applied to tuned couplers to fix the wires in place. Applying the adhesives and waiting for the adhesives to cure may not meet the quality goals (e.g., more production time). Adhesives may vary in hardness and stretchability. Selection based on hardness and stretchability may result in improved performance.

In FIG. 1, the example coupling device 100 may comprise a magnetic core 102, wire windings 103, a surface mount technology (SMT) substrate 104, a tuning wire 105, and an encapsulant 106. The magnetic core 102 may be a ferrite core. The magnetic core 102 may be formed, for example, by a molding process. For example, a powder mixture of iron oxide and other metal oxides may be pressed using a mold to form a desired shape. The wire windings 103 may be formed by positioning (e.g., winding) one or more wires on/around/through the magnetic core 102. For example, a bidirectional coupler is a four port device, and the magnetic core may have two holes. The wire windings 103 may be formed around edges of the holes and through the holes. The SMT substrate 104 may be attached to the magnetic core 102 directly or indirectly, for example, via a brazing process. The encapsulant 106 may be applied on the SMT substrate, for example, to create a protective barrier and/or reduce stress. The tuning wire 105 may protrude from the magnetic core 102 and may have a bent portion (e.g., a bend of 30º-120º, 90º, etc.). The tuning wire 105 may be used for tuning the coupling device 100, for example, in a tuning process. For example, the tuning wire 105 may be moved upward and/or downward. For example, part of the tuning wire 105 may be removed. Various tuning methods may be used with the tuning wire 105. The end(s) of the tuning wire 105 may be encapsulated (e.g., in the encapsulant 106), for example, after the tuning is completed.

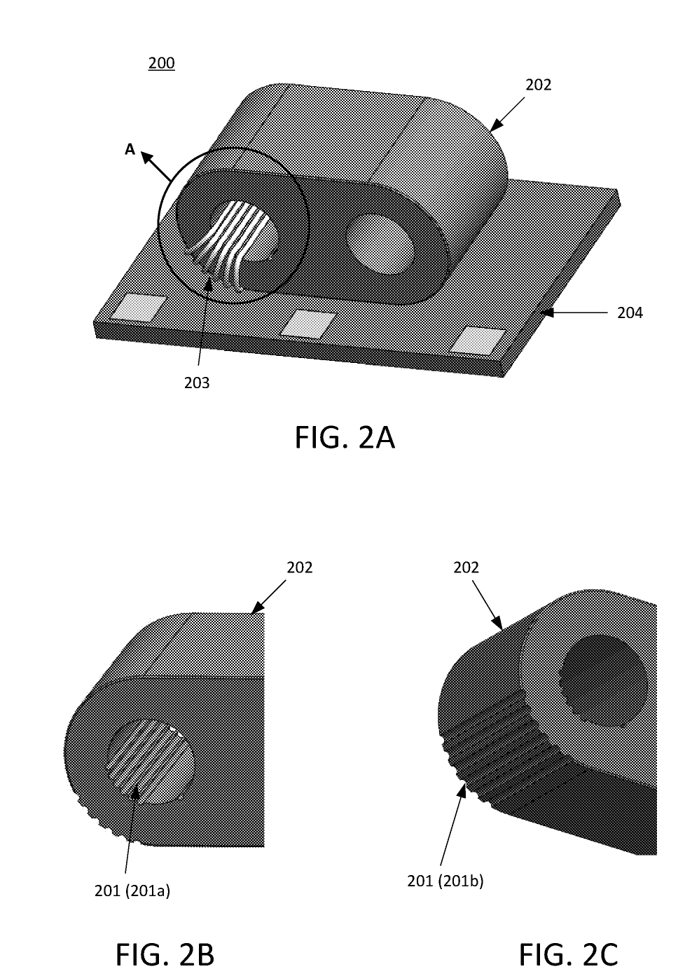

FIG. 2A shows a simplified example of a coupling device with wire channels. In FIG. 2A, a coupling device 200 may comprise a magnetic core 202 and an SMT substrate 204. On the magnetic core 202, wire windings 203 may be shown in an area indicated by a circle and the letter A, for simplicity of illustration. Although not shown, there may be wire windings in other positions of the magnetic core 202. The wire windings 203 may be positioned in/on predetermined wire channels which may be shown in other figures such as FIGS. 2B and 2C.

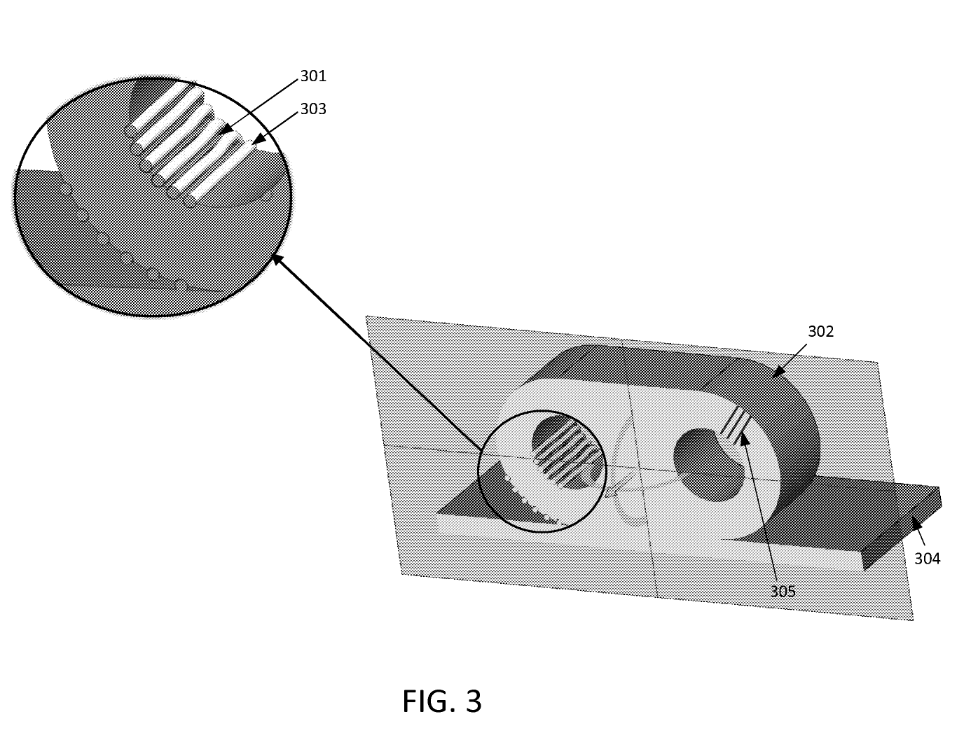

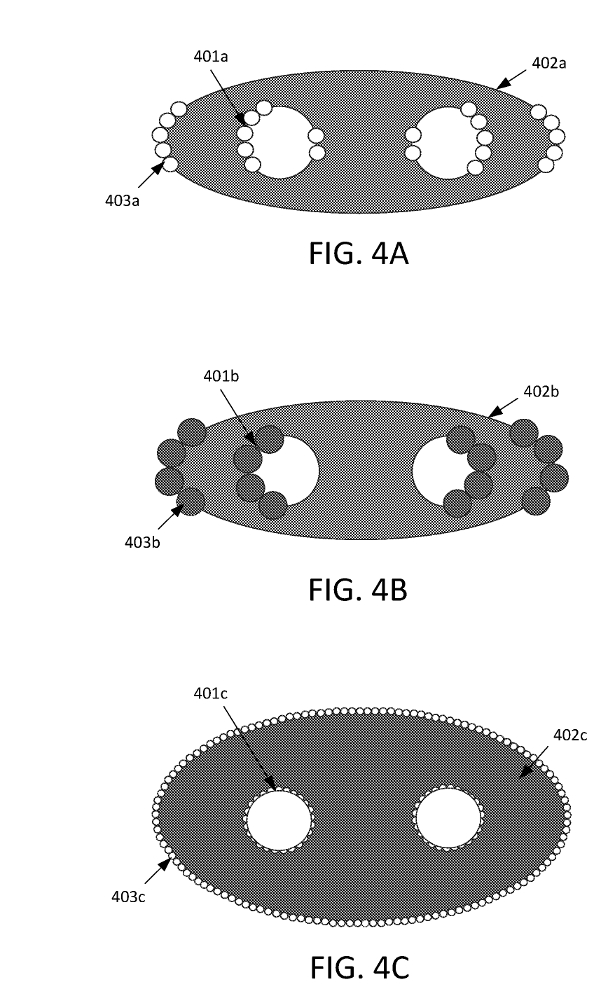

FIG. 2B shows an example of wire channels on a coupling device. In FIG. 2B, a plurality of channels (or wire channels) 201a (collectively referred to as 201) may be formed in/on the magnetic core 202. The channels may be referred to as grooves, tracks, troughs, guides, position guides, slots, concave structures, or any other similar terms. The channels 201 may be configured to position the wire windings 203, for example, to prevent shift of position for the wire windings 203. The channels may comprise shapes, sizes (depth, width, etc.), surfaces, intervals, distributions, etc. that are designed to hold wire windings (or wire(s)) so that the wire windings may stay in position, for example, after submission to heat or significant temperature change (e.g., swing). For example, a channel 201 may be shaped to conform to an outer contour (e.g., a round or curved shape) of a wire. For example, a channel 201 may have a depth that is larger than a diameter of a wire. For example, a channel 201 may comprise uneven inner surfaces to increase friction with the wire inside the channel. The intervals between channels 201 may correspond to predetermined intervals between windings. The intervals may be configured to achieve a desired effect of positioning wire windings (e.g., keeping the windings in position). Alternatively, there may be no intervals (e.g., the channels are positioned next to each other). A quantity/number of channels 201 may correspond to a quantity/number of wire windings. For example, each winding may be positioned in a corresponding channel. Alternatively or additionally, the quantity/number of channels 201 may be smaller than or larger than the quantity/number of wire windings. For example, there may be a large quantity of channels formed in the magnetic core (e.g., see FIG. 4C). A wire winding may be provided with the flexibility to be positioned in any one of multiple available channels. The channels 201 may be parallel to each other. The channels 201 may comprise channels not parallel to each other. The channels 201 may be aligned in a direction of a hole of the magnetic core 202. The channels 201 may comprise channels not aligned in a direction of a hole of the magnetic core 202. The channels 201 may be formed on any part of the magnetic core. For example, the channels 201 may be formed inside a hole of the magnetic core 202 (e.g., as shown by 201a in FIG. 2B). Alternatively or additionally, The channels 201 may be formed in/on an outer surface of a hole (or barrel) of the magnetic core 202 (e.g., as shown by 201b in FIG. 2C). The channels 201 may be formed on/across the path of the wire windings 203. The channels 201 may form in/on one or more end surfaces (e.g., flat surfaces) of the magnetic core 202 (e.g., as shown by 305 in FIG. 3). The channels 201 may keep the positions of the wire windings, and advantages such as isolation stability of the coupling device 200 may be achieved. The transition from one surface to another surface for a channel may be rounded.

FIG. 2C shows an example of wire channels on a coupling device. As described herein, FIG. 2C shows wire channels 201b formed in/on an outer surface of a hole of the magnetic core 202. Features described with respect to FIG. 2B apply to FIG. 2C and may be omitted herein.

FIG. 3 shows an example of wire windings in wire channels. More specifically, FIG. 3 shows an enlarged view of wire windings 303 positioned in/on wire channels 301 of/in/on a magnetic core 302. In the simplified view of FIG. 3, the magnetic core 302 may be attached to a circuit board (e.g., an SMT substrate) 304. In this example, each wire winding 303 may be partially positioned in a corresponding channel 301. For example, a channel 301 may have a depth that is smaller than a diameter of the wire winding 303. Although the wire winding 303 may be partially outside the channel 301, the wire winding 303 may stay in place, for example, due to the friction of a lower portion (e.g., lower half) of the wire with inner surfaces of the channel 301. For example, the wire may expand (e.g., slightly expand) under heat (e.g., generated in a reflow soldering process) and still stay in the channel 301, without shifting the position and losing isolation.

FIGS. 4A, 4B and 4C show examples of distributions and sizes of wire channels. A magnetic core (402a, 402b, 402c) may be formed with a plurality of wire channels (401a, 401b, 401c) configured to position (e.g., place, accommodate, wrap, fit, etc.) a plurality of wire windings (403a, 403b, 403c). The channels may be formed in/on portions of inner surfaces and/or outer surfaces with respect to holes of the magnetic core (e.g., as shown in FIGS. 4A and 4B). Alternatively, the channels may be formed in/on the whole inner surfaces and/or outer surfaces of the holes of the magnetic core (e.g., as shown in FIG. 4C). The channels may be formed in/on both sides of an inner surface of a hole of the magnetic core (e.g., as shown in FIG. 4A). The channels may be formed in/on one side of an inner surface of a hole of the magnetic core (e.g., as shown in FIG. 4B). The channels may be formed based on the quantity and/or size of the wire windings. For example, the channels 401b may comprise fewer quantity of and larger channels, compared to channels 401a. For example, the channels 401c may comprise a maximum quantity of channels, which may increase the flexibility for positioning wire windings (e.g., maximum winding flexibility). Alternatively or additionally, the distribution and sizes of wire channels may be determined based on shape and size of the relevant magnetic core. For example, the magnetic core 402c may be bigger than the magnetic core 402a or 402b. The magnetic core 402c may have a higher capability to form more wire channels.

The wire channels of a magnetic core may be uniform (or consistent). The wire channels of a magnetic core may be non-uniform (or non-consistent). For example, wire channels in one portion of the magnetic core may be different from wire channels in another portion of the magnetic core. The shapes, sizes (depth, width, etc.), surfaces, intervals, distributions of the wire channels may comprise any option that may achieve desired effects. For example, a channel may comprise a V-shape, a U-shape, a curved shape, a flat shape, a combination shape, an unconventional shape, or any other shape that may be appropriate. Those skilled in the art may experiment and determine the best shape for their specific application (e.g., shape, size, material, mechanical properties, etc. of wires, etc.). Similarly, those skilled in the art may experiment and determine the best size, spacing, distribution etc. for their specific application. The wire channels may be formed on the surface(s) of the magnetic core, for example, instead of in the surface(s). For example, the wire channels may comprise protrusions protruding from the surface(s) of the magnetic core. The wire windings or wire(s) may be standard or non-standard wires. For example, a wire may be a bifilar or trifilar wire. In that situation, it may be considered that a wire channel may accommodate more than one wire.

The wire channels may be formed as part of a forming process (e.g., a standard powder metallurgy forming process) for the magnetic core. For example, a mold may be designed/modified/adjusted/changed to include predetermined configurations (shapes, sizes, etc.) for forming (e.g., molding) the channels. No additional step may be needed in manufacturing a coupling device, which may save cost and time. Alternatively, the wire channels may be formed independent of the forming process for the magnetic core. For example, the wire channels may be formed after the magnetic core is formed (e.g., molded). Various technologies such as 3D printing may be used to manufacture magnetic cores with predetermined channels for wire windings.

The wire channels may generate advantages beyond reducing wire position shift and loss of isolation and increasing stability. For example, efficiency of coupling between a magnetic field of the magnetic core and an electrical field of the wire may be improved, for example, due to closer contact (e.g., bigger contact area) of the wire with the magnetic core (e.g., wrapped by the magnetic core).

Additional tuning may be performed, for example, after the reflow soldering process. Readjustment of the wire windings may be performed based on the results of tuning. For example, automated test may be realized by using a robot with a feedback mechanism. The feedback mechanism may comprise a resistor (e.g., a termination resistor) for testing.

The bidirectional coupler as shown in the figures are merely examples. A bidirectional coupler with any other shapes, sizes, structures or configurations may be used. Although the present disclosure may use a bidirectional coupler as an example, it is not limited to bidirectional couplers. Any applications that require isolation stability, positional precision repeatability of wires on a core, and/or positional stability of wires over environment (e.g., temperature) impact may use and benefit from the present disclosure. For example, transformers (e.g., balun transformers, radio frequency (RF) transformers, hybrid transformers, etc.), couplers, splitters, amplifiers, gateways, nodes, or any other magnetic inductive devices may universally adopt and fall within the spirit and scope of the disclosure. While the examples in the present disclosure may show multiple wire channels, it is possible to comprise a single channel in a magnetic core. Configurations of channels such as shapes, sizes, etc. may apply to the single channel.

Although examples are described above, features and/or steps of those examples may be combined, divided, omitted, rearranged, revised, and/or augmented in any desired manner.

Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A coupling device comprising:
a magnetic core comprising a plurality of channels;
a tuning wire extending from the magnetic core, the tuning wire being configured to tune the coupling device; and
a plurality of wire windings,
wherein each wire winding of the plurality of wire windings is at least partially positioned within a corresponding channel of the plurality of channels.

2. The coupling device of claim 1, wherein each wire winding of the plurality of wire windings is positioned completely within the corresponding channel of the plurality of channels.

3. The coupling device of claim 1, wherein a channel of the plurality of channels is shaped to conform to an outer contour of a wire winding of the plurality of wire windings.

4. The coupling device of claim 1, wherein a channel of the plurality of channels has a depth that is larger than a diameter of a wire winding of the plurality of wire windings.

5. The coupling device of claim 1, wherein a channel of the plurality of channels comprises uneven inner surfaces.

6. The coupling device of claim 1, wherein the plurality of channels are formed in an inner surface of a hole of the magnetic core.

7. The coupling device of claim 1, wherein the plurality of channels are formed in an outer surface of a hole of the magnetic core.

8. The coupling device of claim 1, wherein the plurality of channels are formed in an end surface of the magnetic core.

9. The coupling device of claim 1, wherein a channel of the plurality of channels comprises a V-shape, a U-shape, or a curved shape.

10. The coupling device of claim 1, wherein the coupling device is a bidirectional coupler for full duplex (FDX) DOCSIS systems.

11. The coupling device of claim 1, further comprising:
a substrate attached to the magnetic core; and
an encapsulant applied on the substrate.

12. A method comprising:
forming a magnetic core comprising a plurality of channels;
positioning a plurality of wire windings in the plurality of channels so that the plurality of wire windings are fixed in position in the plurality of channels; and
attaching a tuning wire to the magnetic core.

13. The method of claim 12, wherein forming the magnetic core comprises forming the plurality of channels as part of a molding process for the magnetic core.

14. The method of claim 12, wherein forming the magnetic core comprises forming the plurality of channels after the magnetic core is molded.

15. The method of claim 12, further comprising:
performing a reflow soldering process in relation to a surface mount technology substrate, the plurality of wire windings remaining in position during the reflow soldering process.

16. A bidirectional coupler comprising:
a magnetic core comprising a plurality of channels;
a plurality of wire windings positioned within the plurality of channels; and
a surface mount technology substrate attached to the magnetic core,
wherein the plurality of channels are configured to prevent shift of position for the plurality of wire windings during temperature changes.

17. The bidirectional coupler of claim 16, wherein the magnetic core is a ferrite core.

18. The bidirectional coupler of claim 16, further comprising a tuning wire protruding from the magnetic core.

19. The bidirectional coupler of claim 16, further comprising an encapsulant applied on the surface mount technology substrate.

20. The bidirectional coupler of claim 16, wherein a quantity of the plurality of channels corresponds to a quantity of the plurality of wire windings.
